(19) United States
(12) Patent Application Publication
(10) Pub. No.: US 2007/0214210 A1
(43) Pub. Date: Sep. 13, 2007

(54) Display of web page code

(76) Inventors: Chavdar Blagoev Mechov, Sofia (BG); Vladimir Stoyanov Enchev, Sofia (BG)

Correspondence Address: FISH & RICHARDSON PC, P.O. BOX 1022, MINNEAPOLIS, MN, 55440-1022, US

(21) Appl. No.: 11/372,837

(22) Filed: Mar. 10, 2006

(51) Int. Cl. G06F 15/16

(52) U.S. Cl. 709/203; 709/201

(57) ABSTRACT

Among other things, on a client, on which a web browser can run, unprocessed markup is stored which represents a first portion of a web page, in a manner to be inaccessible for display by the browser.

### BACKGROUND

Typical web browsers enable a user to view not only a web page (including its graphics, text, advertisements, and so on, but also to view the source code that underlies the web page. The client markup of a webpage is typically HTML (“hyper-text markup language”) or another variant of HTML such as eXtensible HyperText Markup Language (XHTML), etc. The client markup may also contain computer code that can be executed by the browser, typically JavaScript. Web pages can be generated using a variety of languages, including hypertext markup language (HTML), or ASP, which stands for “active server page.” One version of ASP is called ASP.NET. Web pages served to a browser may include computer programs that are executed on the user's computer.

### SUMMARY

In general, in one aspect, on a client, on which a web browser can run, storing unprocessed markup which represents a first portion of a web page, in a manner to be inaccessible for display by the browser.

Implementations may include one or more of the following features. The first portion is requested from a server. The requesting comprises executing on the client a program received from the server. The program is received as part of markup which represents a second portion of the web page. The markup which represents the second portion of the web page is incorporated with the markup that represents the first portion of the web page to form an incorporated markup which represents a web page. The web page is passed to the browser. The unprocessed markup representing the first portion of the web page comprises placeholders for content.

In general, one aspect includes incorporating in an active server page a first control to generate a portion of a web page and a second control to generate placeholders associated with content of a web page.

Implementations may include one or more of the following features. The portion of the web page includes a program. The program is configured to request content from the server when executed on a client. In response to the request, content is generated at the server using the second control.

In general, in one aspect content is received from a server to replace placeholders in unprocessed markup representing a portion of a web page, the content being inaccessible by a browser running on the client for display to a user.

In general, in one aspect on a server, a control of an active server page is used to generate content to be used to replace a placeholder contained in markup at the client, the placeholder having been generated by the control.

Other aspects include other combinations of the features recited above and other features, expressed as methods, apparatus, systems, program products, and in other ways.

Other features and advantages will be apparent from the description and from the claims.

### DESCRIPTION

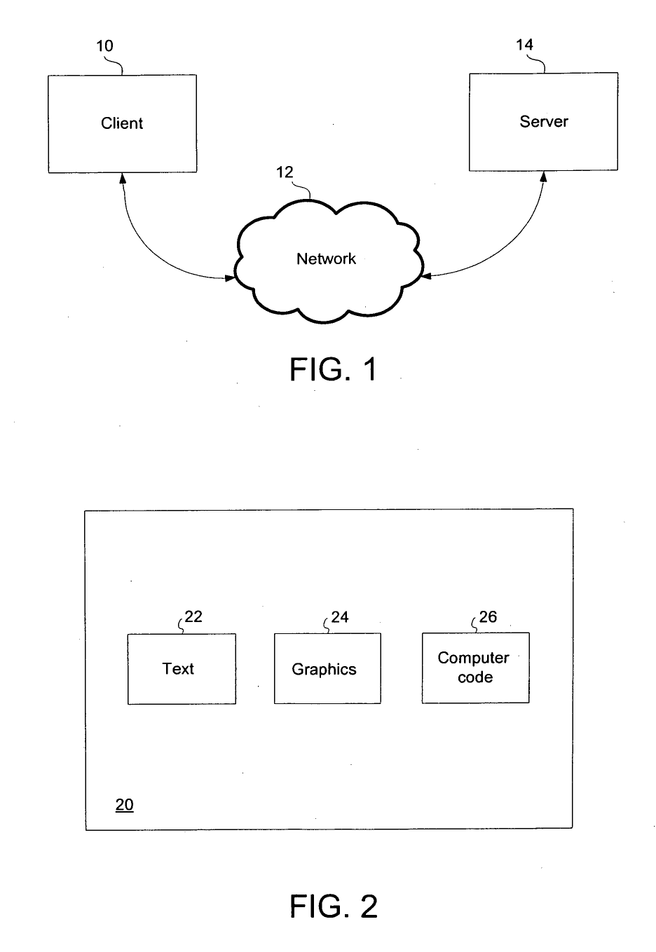

FIG. 1 is a block diagram of a computer connected to a server across a network.

FIG. 2 shows a layout of a web page.

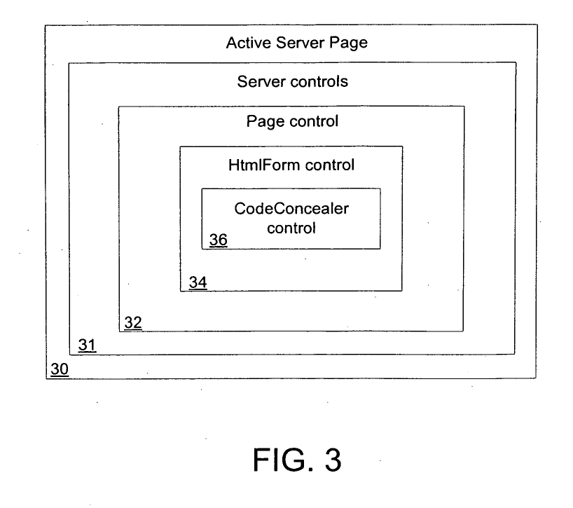

FIG. 3 is a block diagram of an active server page.

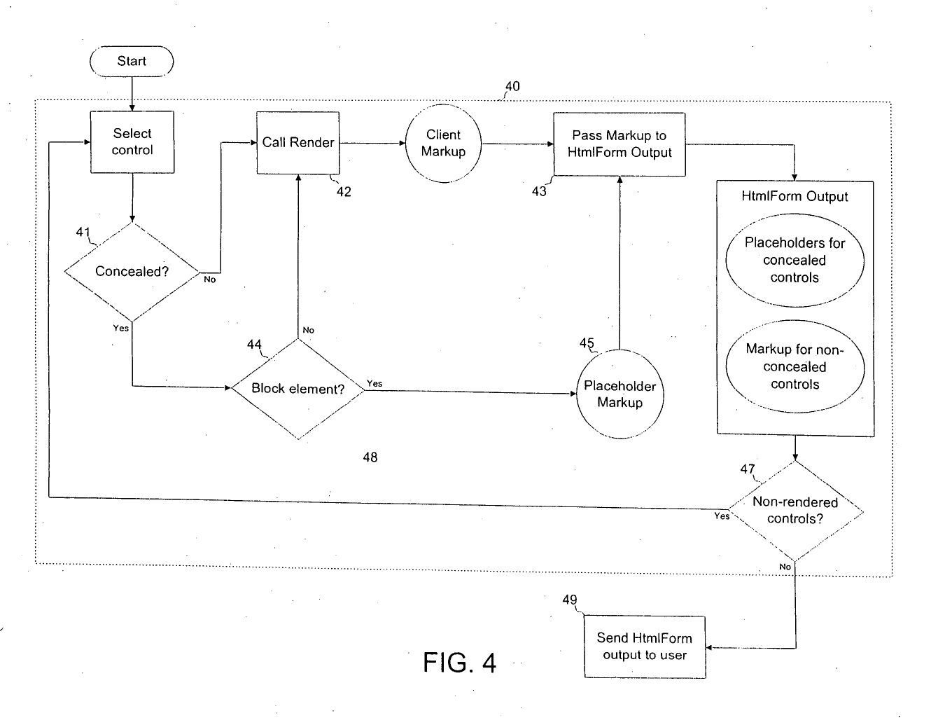

FIG. 4 is a flowchart of a CustomRender method.

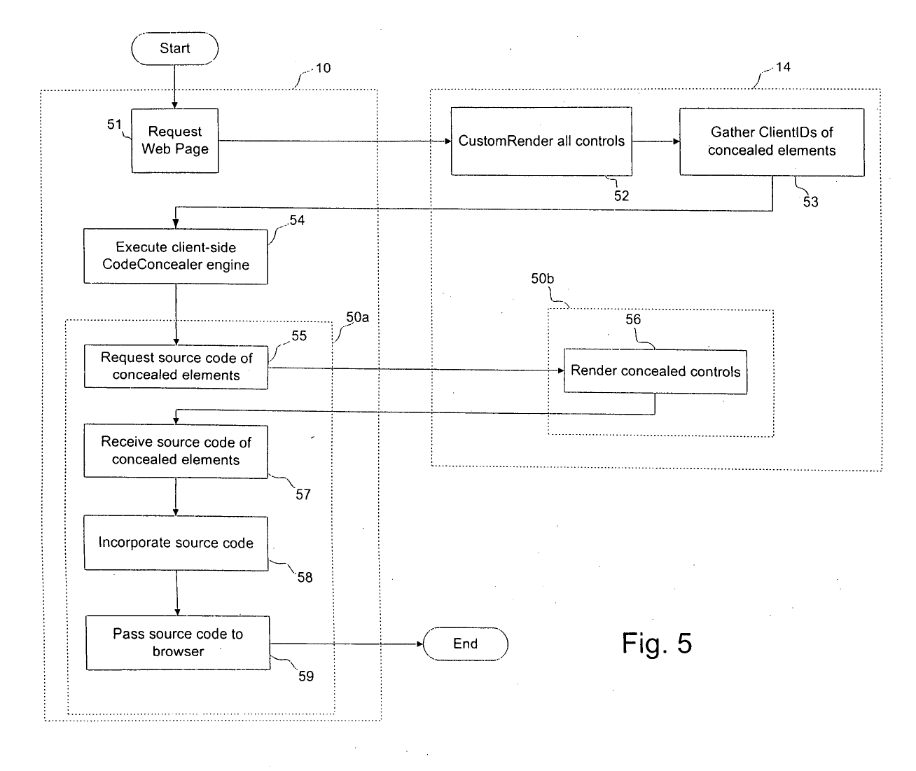

FIG. 5 is a flowchart of displaying a web page.

In FIG. 1, a client 10 is connected to a server 14 across a network 12. The network may be a local area network (LAN), a wide area network (WAN), or the Internet, for example. When the Internet is used to give access to the World Wide Web, a browser running on the client 10 sends requests to the server 14 which returns data used to display a web page to a user of the client 10.

In FIG. 2, a client markup for a web page 20 can contain computer instructions to cause the browser to display text 22 or graphics 24 and other computer code 26 to provide other features of the web page.

Typically, when the browser requests a web page 20 from the server 14, what the server returns is the client markup that enables the browser to display the web page 20. Examples of web browsers include Firefox, Netscape, or Internet Explorer. The browser is typically capable of displaying, at the option of the user, the client markup of the web page 20 instead of the processed content of the web page 20. However, it is sometimes useful for the author of the web page 20 or another party to limit users' ability to display the client markup. For example, viewing the client markup of a web page 20 may reveal unique programming techniques or information about the server 14 that the author of the web page 20 or the server administrator would prefer to keep secret. In some implementations, the web page 20 is generated using the collection of web-development tools known as ASP.NET, available from Microsoft Corporation. ASP.NET is an implementation of a concept known as ASP (“active server page”).

Referring to FIG. 3, to generate a web page 20 using ASP or ASP.NET, the author of the web page 20 creates a separate “active server page” 30. The active server page 30 is a file or group of files that resides on the server 14 and contains instructions for generating the client markup of the web page 20. When a request arrives from a browser, the server 14 can use the active server page 30 to dynamically generate content to be served back to the client 10 in response to the request. The active server page 30 has a variety of server controls 31. Some server controls 31 allow the author of the active server page 30 to organize its constituent parts. For example, the Page control 32 is a server control in which names of other server controls are collected. Within the Page control 32, there is an HtmlForm control 34. Generally, names of controls which interact with the server 14 are collected in the HtmlForm control 34. Each server control 36₁, . . . , 36ₘ named in the HtmlForm control 34 generally corresponds with an element of the web page 20.

When the active server page 30 is requested by a user's browser, the server uses the instructions of the active server page to generate the client markup of the web page 20. The server then sends the client markup of the web page 20 to the client 10, where the browser software processes the client markup and displays the content and features of the web page 20.

The HtmlForm control 34 names a CodeConcealer control 36. As described more fully below, the CodeConcealer control 36 corresponds to a CodeConcealer engine, and is used to prevent the user from viewing author-specified portions of client markup of the web page 20. When authoring the active server page 30, some or all of the HtmlForm controls 34 (except the CodeConcealer control 36 itself) can be selected by the author as controls that will produce concealed client markup at the user's browser.

In response to a request from a user's browser, the active server page 30 will generate the client markup of a web page 20. In a traditional ASP.NET implementation, the web page is generated by a “Render” command, referred to as “Render” method. The replacement may be made using the SetRenderMethodDelegate command in ASP.NET implementations. The “Render” method of the Page control 32 is replaced with a modified method denoted CustomPageRender, and the “Render” method of the HtmlForm control 34 is replaced with a modified method denoted CustomHtmlFormRender.

FIG. 4 shows a loop 40 performed by the CustomHtmlFormRender method at the server. CustomHtmlFormRender cycles through each of the HtmlForm controls 34 in turn, and for each HtmlForm control generates a corresponding portion of client markup that will implement the given control in the web page 20 when executed by the browser. The portions of the client markup are ultimately assembled to form the complete web page 20.

For a given control, the CustomHtmlFormRender method determines whether the control corresponds to an element of the web page 20 which should be concealed (step 41). If so, the control is referred to as a “concealed” control. Note that the control is called concealed because it corresponds to an element of the web page 20 the client markup of which is to be concealed from the user as described below, not because the control itself cannot be viewed by the user. In fact, typically, none of the controls of an active server page 30 are viewable to a user.

If a given control is not a concealed control, the CustomHtmlFormRender method simply calls the (traditional) Render method (step 42). The traditional Render method generates a portion of client markup corresponding to the control and passes the client markup portion to the HtmlForm output (step 43). CustomHtmlFormRender determines if the given control corresponds to a “block” element or an “inline” element of the web page 20 (step 44). A “block” element is an element that can nest other elements. An inline element is an element different from a block element. If the control corresponds to an “inline” element of the web page 20, the element is rendered using the traditional Render method.

On the other hand, if a given control is concealed and corresponds to a block element, the CustomHtmlFormRender method produces a “placeholder” portion of client markup (step 45). The placeholder markup does not contain details of the concealed element, such as portions of its client markup. Optionally, the placeholder markup can contain details of the element, such as its ID, attributes, or placement in the web page 20. For example, placeholder markup may be:
<div id=“Division1” style=“width:200px”></div>.
   This placeholder code specifies that the concealed element is a division with ID equal to “Division1” and width 200 px. No other details of the division are present. Furthermore, none of the elements nested in the division are rendered. CustomHtmlFormRender passes the placeholder markup portion produced by step 45 to the HtmlForm output (step 43).

As an example, suppose the client markup corresponding to a web sample page with a calendar control, which has not been concealed is the following:

<!DOCTYPE html PUBLIC “-//W3C//DTD XHTML 1.0 Transitional//EN”
“http://www.w3.org/TR/xhtml1/DTD/xhtml1-transitional.dtd”>
<html xmlns=“http://www.w3.org/1999/xhtml”>
<head><title>

Untitled Page

</title></head>
<body>

<form name=“form1” method=“post” action=“Calendar.aspx” id=“form1”>

<input type=“hidden” name=“_EVENTTARGET” id=“_EVENTTARGET”
value=“” />
<input type=“hidden” name=“_EVENTARGUMENT” id=“_EVENTARGUMENT”
value=“” />
<input type=“hidden” name=“_VIEWSTATE” id“_VIEWSTATE”
value=“/wEPDwULLTE1Mjk2MTIxNjNkGAEFHl9fQ29udHJvbHNSZXF1aXJ1UG9zdEJhY2tLZXlfXxYBB
Q5SYWRBdGxhc1BhbmVsMWntoPZqstVl0cwYOdTpnGBjEg+S” />
<script type=“text/javascript”>
<!—
var theForm = document.forms[′form1′];
if(!theForm) {

theForm = document.form1;

}
function_doPostBack(eventTarget, eventArgument) {

if(!theForm.onsubmit ∥ (theForm.onsubmit( ) != false)) {

theForm._EVENTTARGET.value = eventTarget;
theForm._EVENTARGUMENT.value = eventArgument;
theForm.submit( );
}
}
// —>
</script>

<div>

<table id=“RadAjaxPanel1_Calendar1” cellspacing=“0”
cellpadding=“2” title=“Calendar” border=“0”

style=“border-width:1px;border-style:solid;border-collapse:collapse;”>

<tr><td colspan=“7” style=“background-color:Silver;”>
<table cellspacing=“0” border=“0”

style=“width:100%;border-collapse:collapse;”>

<tr><td style=“width:15%;”><a href=“javascript:_doPostback
(′Calendar1′,′V2192′)”

style=“color:Black” title=“Go to the previous month”>&lt;</a></td>
<td align=“center”
style=“width:70%;”>February 2006</td><td align=“right”
style=“width:15%;”><a
href=“javascript:_doPostback(′Calendar1′,′V2251′)” style=“color:Black”
title=“Go to the next month”>&gt;</a></td></tr>

</table></td></tr><tr><th align=“center” abbr=“Sunday”
scope=“col”>Sun</th><th align=“center”

abbr=“Monday” scope=“col”>Mon</th><th align=“center”
abbr=“Tuesday” scope=“col”>Tue</th><th
align=“center” abbr=“Wednesday” scope=“col”>Wed</th>
<th align=“center” abbr=“Thursday”
scope=“col”>Thu</th><th align=“center” abbr=“Friday”
scope=“col”>Fri</th><th align=“center”
abbr=“Saturday” scope=“col”>Sat</th></tr><tr><td align=“center”
style=“width:14%;”><a
href=“javascript:_doPostback(′Calendar1′,′2220′)” style=“color:Black”
title=“January 29”>29</a></td><td
align=“center” style=“width:14%;”><a href=“javascript:_doPostback
(′Calendar1′,′2221′)” style=“color:Black”
title=“January 30”>30</a></td><td align=“center” style=“width:14%;”><a
href=“javascript:_doPostback(′Calendar1′,′2222′)” style=“color:Black”
title=“January 31”>31</a></td><td
align=“center” style=“width:14%;”><a href=“javascript:_doPostback
(′Calendar1′,′2223′)” style=“color:Black”
title=“February 01”>1</a></td><td align=“center”
style=“width:14%;”><a
href=“javascript:_doPostback(′Calendar1′,′2224′)” style=“color:Black”
title=“February 02”>2</a></td><td
align=“center” style=“width:14%;”><a href=“javascript:_doPostback
(′Calendar1′,′2225′)” style=“color:Black”
title=“February 03”>3</a></td><td align=“center”
style=“width:14%;”><a
href=“javascript:_doPostback(′Calendar1′,′2226′)” style=“color:Black”
title=“February 04”>4</a></td></tr><tr><td align=“center”
style=“width:14%;”><a
href=“javascript:_doPostback(′Calendar1′,′2227′)” style=“color:Black”
title=“February 05”>5</a></td><td
align=“center” style=“width:14%;”><a href=“javascript:_doPostback
(′Calendar1′,′2228′)” style=“color:Black”
title=“February 06”>6</a></td><td align=“center”
style=“width:14%;”><a
href=“javascript:_doPostback(′Calendar1′,′2229′)” style=“color:Black”
title=“February 07”>7</a></td><td
align=“center” style=“width:14%;”><a href=“javascript:_doPostback
(′Calendar1′,′2230′)” style=“color:Black”
title=“February 08”>8</a></td><td align=“center”
style=“width:14%;”><a
href=“javascript:_doPostback(′Calendar1′,′2231′)” style=“color:Black”
title=“February 09”>9</a></td><td
align=“center” style=“width:14%;”><a href=“javascript:_doPostback
(′Calendar1′,′2232′)” style=“color:Black”
title=“February 10”>10</a></td><td align=“center”
style=“width:14%;”><a
href=“javascript:_doPostback(′Calendar1′,′2233′)” style=“color:Black”
title=“February 11”>11</a></td></tr><tr><td align=“center”
style=“width:14%;”><a
href=“javascript:_doPostback(′Calendar1′,′2234′)” style=“color:Black”
title=“February 12”>12</a></td><td
align=“center” style=“width:14%;”><a href=“javascript:_doPostback
(′Calendar1′,′2235′)” style=“color:Black”
title=“February 13”>13</a></td><td align=“center”
style=“width:14%;”><a
href=“javascript:_doPostback(′Calendar1′,′2236′)” style=“color:Black”
title=“February 14”>14</a></td><td
align=“center” style=“width:14%;”><a href=“javascript:_doPostback
(′Calendar1′,′2237′)” style=“color:Black”
title=“February 15”>15</a></td><td align=“center”
style=“width:14%;”><a
href=“javascript:_doPostback(′Calendar1′,′2238′)” style=“color:Black”
title=“February 16”>16</a></td><td
align=“center” style=“width:14%;”><a href=“javascript:_doPostback
(′Calendar1′,′2239′)” style=“color:Black”
title=“February 17”>17</a></td><td align=“center”
style=“width:14%;”><a
href=“javascript:_doPostback(′Calendar1′,′2240′)” style=“color:Black”
title=“February 18”>18</a></td></tr><tr><td align=“center”
style=“width:14%;”><a
href=“javascript:_doPostback(′Calendar1′,′2241′)” style=“color:Black”
title=“February 19”>19</a></td><td
align=“center” style=“width:14%;”><a href=“javascript:_doPostback
(′Calendar1′,′2242′)” style=“color:Black”
title=“February 20”>20</a></td><td align=“center”
style=“width:14%;”><a
href=“javascript:_doPostback(′Calendar1′,′2243′)” style=“color:Black”
title=“February 21”>21</a></td><td
align=“center” style=“width:14%;”><a href=“javascript:_doPostback
(′Calendar1′,′2244′)” style=“color:Black”
title=“February 22”>22</a></td><td align=“center”
style=“width:14%;”><a
href=“javascript:_doPostback(′Calendar1′,′2245′)” style=“color:Black”
title=“February 23”>23</a></td><td
align=“center” style=“width:14%;”><a href=“javascript:_doPostback
(′Calendar1′,′2246′)” style=“color:Black”
title=“February 24”>24</a></td><td align=“center”
style=“width:14%;”><a
href=“javascript:_doPostback(′Calendar1′,′2247′)” style=“color:Black”
title=“February 25”>25</a></td></tr><tr><td align=“center”
style=“width:14%;”><a
href=“javascript:_doPostback(′Calendar1′,′2248′)” style=“color:Black”
title=“February 26”>26</a></td><td
align=“center” style=“width:14%;”><a href=“javascript:_doPostback
(′Calendar1′,′2249′)” style=“color:Black”
title=“February 27”>27</a></td><td align=“center”
style=“width:14%;”><a
href=“javascript:_doPostback(′Calendar1′,′2250′)” style=“color:Black”
title=“February 28”>28</a></td><td
align=“center” style=“width:14%;”><a href=“javascript:_doPostback
(′Calendar1′,′2251′)” style=“color:Black”
title=“March 01”>1</a></td><td align=“center”
style=“width:14%;”><a
href=“javascript:_doPostback(′Calendar1′,′2252′)” style=“color:Black”
title=“March 02”>2</a></td><td
align=“center” style=“width:14%;”><a href=“javascript:_doPostback
(′Calendar1′,′2253′)” style=“color:Black”
title=“March 03”>3</a></td><td align=“center”
style=“width:14%;”><a
href=“javascript:_doPostback(′Calendar1′,′2254′)” style=“color:Black”
title=“March 04”>4</a></td></tr><tr><td align=“center”
style=“width:14%;”><a
href=“javascript:_doPostback(′Calendar1′,′2255′)” style=“color:Black”
title=“March 05”>5</a></td><td
align=“center” style=“width:14%;”><a href=“javascript:_doPostback
(′Calendar1′,′2256′)” style=“color:Black”
title=“March 06”>6</a></td><td align=“center”
style=“width:14%;”><a
href=“javascript:_doPostback(′Calendar1′,′2257′)” style=“color:Black”
title=“March 07”>7</a></td><td
align=“center” style=“width:14%;”><a href=“javascript:_doPostback
(′Calendar1′,′2258′)” style=“color:Black”
title=“March 08”>8</a></td><td align=“center”
style=“width:14%;”><a
href=“javascript:_doPostback(′Calendar1′,′2259′)” style=“color:Black”
title=“March 09”>9</a></td><td
align=“center” style=“width:14%;”><a href=“javascript:_doPostback
(′Calendar1′,′2260′)” style=“color:Black”
title=“March 10”>10</a></td><td align=“center”
style=“width:14%;”><a
href=“javascript:_doPostback(′Calendar1′,′2261′)” style=“color:Black”
title=“March 11”>11</a></td></tr>

</table>

<br/>
<input name=“RadAjaxPanel1:TextBox1” type=“text” readonly=“readonly”

id=“RadAjaxPanel1_TextBox1” />

<div><input type=“hidden” name=“RadAjaxPanel1PostDataValue”
id=“RadAjaxPanel1PostDataValue”

value=“” /></div>
<script type=“text/javascript” src=“/r.a.d.Ajax_Net2/RadControls/Ajax/Scripts/
1_0_0/RadAjax.js”></script>
<script type=“text/javascript”>window[“AjaxPanel_RadAjaxPanel1”] = new
RadAjaxNamespace.RadAjaxPanel( {ClientID:“RadAjaxPanel1”,EnableAjaxCreation:false,IsAjaxCreated:false,
Url:“/r.a.d.Ajax_Net2/Calendar.aspx”} )</script>

<br />
<input type=“submit” name=“Button1” value=“PostBack”
id=“Button1” />

</div>

<input type=“hidden” name=“_EVENTVALIDATION”
id=“_EVENTVALIDATION”
value=“/wEWLwLs2bf4CALQ98fJAgLMnvqGAwLt44zLBALt4+CvCwLt49SCAgLt48jZCgLt47y8AQLt45C
TCALt44R2Au3j+MoHAu3jrPIKAu3jgMkBAsqKk74OAsqKh5UFAsqK++kNAsqK78wEAsqKw6MLAsqKt4
YCAsqKq90KAsqKn7ABAsqKs9kEAsqKp7wLAqewsaUIAqewpXgCp7CZ3wcCp7CNsg4Cp7DhlgUCp7DV
7Q0Cp7DJwAQCp7C9pwsCp7DRzA4Cp7DFowUCnN/XiAICnN/L7woCnN+/wgECnN+TmQgCnN+HfAKc3
/vQBwKc3++3DgKc38OKBQKc3/ezCAKc3+uWDwL5xvX/DQL5xunSBAKs1ePJAgKM54rGBIVWdhJx0V
T6xp+XQRO6QH3A4xQO″ /></form>
</body>
</html>

Then the concealed version of the same client markup would be as follows.

<!DOCTYPE html PUBLIC “-//W3C//DTD XHTML 1.0 Transitional//EN”
“http://www.w3.org/TR/xhtml1/DTD/xhtml1 -transitional.dtd”>
<html xmlns=“http://www.w3.org/1999/xhtml”>
<head><title>

Untitled Page

</title></head>
<body>

<form name=“form1” method=“post” action=“Calendar.aspx” id=“form1”>

<input type=“hidden” name=“_EVENTTARGET” id=“_EVENTTARGET”
value=“”/>
<input type=“hidden” name=“_EVENTARGUMENT” id=“_EVENTARGUMENT”
value=“”/>
<input type=“hidden” name=“_VIEWSTATE” id=“_VIEWSTATE”
value=“/wEPDwULLTE1Mjk2MTIxNjNkGAEFHl9fQ29udHJvbHNSZXF1aXJlUG9zdEJhY2tLZX1fXxYBB
Q5SYWRBdGxhc1BhbmVsMWntoPZqstV10cwYOdTpnGBjEg+S″ />
<script type=“text/javascript”>
<!—
var theForm = document.forms[′form1′];
if(!theForm) {

theForm = document.form1;

}
function_doPostBack(eventTarget, eventArgument) {

if(!theForm.onsubmit ∥ (theForm.onsubmit( ) != false)) {

theForm._EVENTTARGET.value = eventTarget;
theForm._EVENTARGUMENT.value = eventArgument;
theForm.submit( );

}

}
// —>
</script>

<div>

<div id=“RadAjaxPanel1”>

<div><input type=“hidden” name=“RadAjaxPanel1PostDataValue”
id=“RadAjaxPanel1PostDataValue”
value=“”/></div>
<script type=“text/javascript” src=“/r.a.d.Ajax_Net2/RadControls/Ajax/Scripts/
1_0_0/RadAjax.js”></script>
<script type=“text/javascript”>window[“AjaxPanel_RadAjaxPanel1”] = new
RadAjaxNamespace.RadAjaxPanel( {ClientID:“RadAjaxPanel1”,EnableAjaxCreation:true,IsAjaxCreated:false,
Url:“/r.a.d.Ajax_Net2/Calendar.aspx”} )</script>
</div>

<br/>
<input type=“submit” name=“Button1” value=“PostBack” id=“Button1”/>

</div>

<input type=“hidden” name=“_EVENTVALIDATION” id=
“_EVENTVALIDATION”
value=“/wEWLwLs2bf4CALQ98fJAgLMnvqGAwLt44zLBALt4+CvCwLt49SCAgLt48jZCgLt47y8AQLt45C
TCALt44R2Au3j+MoHAu3jrPIKAu3jgMkBAsqKk74OAsqKh5UFAsqK++kNAsqK78wEAsqKw6MLAsqKt4
YCAsqKq90KAsqKn7ABAsqKs9kEAsqKp7wLAqewsaUIAqewpXgCp7CZ3wcCp7CNsg4Cp7DhlgUCp7DV
7Q0Cp7DJwAQCp7C9pwsCp7DRzA4Cp7DFowUCnN/XiAICnN/L7woCnN+/wgECnN+TmQgCnN+HfAKc3
/vQBwKc3++3DgKc38OKBQKc3/ezCAKc3+uWDwL5xvX/DQL5xunSBAKs1ePJAgKM54rGB1VWdhJx0V
T6xp+XQRO6QH3A4xQO″ /></form>
</body>
</html>

CustomHtmlFormRender determines whether there are any other controls that have not been rendered (step 47). If so, a non-rendered control is selected (step 48) and rendered as described above. If all controls have been rendered, then the HtmlForm output is complete and is sent (step 49) to the client 10. If any of the controls of the active server page 30 are concealed, then the client markup for those controls that is sent to the client's browser is only a “shell” for the full client markup of the web page 20. That is, the client markup sent in step 49 does not contain instructions necessary for the browser software on the client 10 to display the concealed elements of the web page 20. Instead, the client markup sent in step 49 merely contains placeholders indicating where the concealed client markup would be if it were not concealed.

In order for browser software on the client 10 to display the concealed controls of the web page 20, the browser software must be provided with the concealed client markup in some manner. To that end, the CodeConcealer control 36 contains computer code for a portion of a CodeConcealer engine. This portion is referred to as the “client-side” of the CodeConcealer engine, because it is executed on the client 10. There is a complementary program running on the server 14, called the “server-side” of the CodeConcealer engine. Typically, the client-side CodeConcealer engine is written in a cross-browser client scripting language, typically JavaScript. The client-side CodeConcealer engine may be written in other languages.

When the CodeConcealer control 36 is rendered by CustomRender, the code for the client-side CodeConcealer engine will be incorporated into the client markup of the web page 20. Additionally, the CustomRender method provides the client-side CodeConcealer engine with two pieces of information: a uniform resource locator (URL) of the web page 20 and ClientID(s) of the web elements that are to be concealed. Because the CodeConcealer control 36 is not specified as concealed, its corresponding client markup is passed to the browser and can be viewed by the user.

As shown in FIG. 5, the client-side CodeConcealer engine 50a interacts with the server-side CodeConcealer engine 50b when a web page 20 with concealed elements is loaded at the browser. When the web page 20 is initially requested (step 51), the server uses the active server page 30 to render the web page 20 using the CustomRender method (step 52). The CustomRender method gathers the ClientIDs of all the web page elements to be concealed (step 53) and provides them to the server side CodeConcealer engine control 36. The concealed client markup of the web page 20 is transferred to the client 10. When the client markup is processed by the browser software of the client 10, the client-side CodeConcealer engine is executed (step 54). The client-side CodeConcealer engine 50a makes a request to the server-side CodeConcealer engine 50b to obtain the client markup for the concealed elements of the web page 20 (step 55). The server-side CodeConcealer engine 50b creates the client markup by using the (traditional) Render method on the concealed controls (step 56). The client-side CodeConcealer engine 50a receives the client markup corresponding to the concealed elements of the web page 20 (step 57). In some implementations, this received client markup is stored on the client 10 in a location different from the location of the client markup generated in step 52, e.g. in another location of the memory of the client 10. The client-side CodeConcealer engine 50a incorporates the client markup corresponding to the concealed elements into the client markup generated in step 52 (step 58), to produce the full client markup of the web page 20. This incorporation is accomplished by replacing “placeholder” code generated by the CustomRender method with the client markup generated in step 55 of the corresponding control. The new markup of the page is then displayed by the browser.

In some implementations, when the client-side CodeConcealer engine 50a is executed (step 54), it creates a new object of type XmlHttpRequest. The client-side CodeConcealer engine collects all the values of all the form elements and hidden fields (if any). The client-side CodeConcealer engine 50a calls the “Open” method of the XmlHttpRequest object, passing three parameters: The URL of the web page 20, the ClientIDs of the concealed elements of the web page 20, and the type of request (“Post” or “Get”). In some implementations, the type of request is “Post.” Additionally, the client-side CodeConcealer engine begins monitoring the status and readyState of the XmlHttpRequest object, to determine when the request has been completed. The request is completed when the status equals 200 and the readyState equals 4. The client-side CodeConcealer engine 50a then calls the Send method of the XmlHttpRequest object, providing as parameters the ClientID of the client-side CodeConcealer engine 50a.

The server-side CodeConcealer engine 50b receives the request made by the XmlHttpRequest object. Initially, the server-side CodeConcealer engine 50b checks to ensure whether the request comes from the client-side CodeConcealer engine 50a by comparing the ClientID of the request to the known value of the client-side CodeConcealer engine 50a. If the request comes from the client-side CodeConcealer engine 50a, the server-side CodeConcealer engine 50b renders the concealed controls using the traditionalRender method. The output of the Render method is unconcealed client markup corresponding to the controls. In some implementations, the unconcealed client markup is HTML and possibly JavaScript. This unconcealed client markup is sent back to the XmlHttpRequest object on the client 10. Optionally, new values of form elements or hidden values (if any) may be sent with the unconcealed client markup.

When the XmlHttpRequest receives the client markup, its status equals 200 and its readyState equals 4. Thus, the client-side CodeConcealer engine 50a obtains the unconcealed client markup by retrieving the value of the reponseText property of the XmlHttpRequest object. The client-side CodeConcealer engine then replaces each “placeholder” with the corresponding section of unconcealed client markup. Optionally, old values of form elements or hidden values may also be replaced by new values. If the unconcealed client markup contains any JavaScript, this JavaScript is executed to ensure proper initialization.

Other embodiments are within the scope of the following claims.

1. A method comprising
on a client, on which a web browser can run, storing unprocessed markup which represents a first portion of a web page, in a manner to be inaccessible for display by the browser.

2. The method of claim 1 also including requesting the first portion from a server.

3. The method of claim 2 in which the requesting comprises executing on the client a program received from the server.

4. The method of claim 3 in which the program is received as part of markup which represents a second portion of the web page.

5. The method of claim 4 also including incorporating the markup which represents the second portion of the web page with the markup that represents the first portion of the web page to form an incorporated markup which represents a web page.

6. The method of claim 5 also including passing the web page to the browser.

7. The method of claim 1 in which the unprocessed markup representing the first portion of the web page comprises placeholders for content.

8. A method comprising
incorporating in an active server page a first control to generate a portion of a web page and a second control to generate placeholders associated with content of a web page.

9. The method of claim 8 in which the portion of the web page includes a program.

10. The method of claim 9 in which the program is configured to request content from the server when executed on a client.

11. The method of claim 10 also including, in response to the request, generating content at the server using the second control.

12. A method comprising
on a client, receiving content from a server to replace placeholders in unprocessed markup representing a portion of a web page, the content being inaccessible by a browser running on the client for display to a user.

13. A method comprising
on a server, using a control of an active server page to generate content to be used to replace a placeholder contained in markup at the client, the placeholder having been generated by the control.

14. A medium bearing instructions to cause an apparatus to
on a client, on which a web browser can run, store unprocessed markup which represents first portion of a web page, in a manner to be inaccessible for display by the browser.

15. A medium bearing instructions to cause an apparatus to
incorporate in an active server page a first control to generate a portion of a web page and a second control to generate placeholders associated with content of a web page.

16. A medium bearing instructions to cause an apparatus to
on a client, receive content from a server to replace placeholders in unprocessed markup representing a portion of a web page, the content being inaccessible by a browser running on the client for display to a user.

17. A medium bearing instructions to cause an apparatus to
on a server, use a control of an active server page to generate content to be used to replace a placeholder contained in markup at the client, the placeholder having been generated by the control.
